(19) United States
(12) Patent Application Publication
(10) Pub. No.: US 2012/0261206 A1
(43) Pub. Date: Oct. 18, 2012

(54) BATTERY BLOCK, BATTERY MODULE, AND BATTERY PACK ARRANGEMENT STRUCTURE

(76) Inventors: Shunsuke Yasui, Osaka (JP); Shinya Geshi, Osaka (JP); Kazutaka Shimizu, Hyogo (JP)

(21) Appl. No.: 13/517,939

(22) PCT Filed: Nov. 17, 2011
(86) PCT No.: PCT/JP2011/006409

§ 371 Date: Jun. 20, 2012

(30) Foreign Application Priority Data
Nov. 30, 2010 (JP) 2010-267521

(51) Int. Cl. B60K 1/04

(52) U.S. Cl. 180/274

(57) ABSTRACT

A battery block for vehicle use which includes a shock absorbing member for absorbing impact force of a crash is provided without increasing the entire size of the battery module.

The battery block for vehicle use which includes an accommodation section accommodating a plurality of cells serving as secondary batteries, and an exhaust passage including space allowing a flow of gas generated from at least one of the cells includes a shock absorbing member, wherein when impact of a vehicle crash is exerted on the battery block, the shock absorbing member deforms to reduce the space of the exhaust passage so as to absorb the impact.

### TECHNICAL FIELD

The present invention relates to battery blocks, battery modules, and battery pack arrangement structures.

### BACKGROUND ART

Battery modules including a plurality of batteries accommodated in a case to be capable of outputting a predetermined voltage and capacitance are widely used as power supplies of various devices, vehicles, etc. and household power supplies. Specifically, the technique of forming modules by connecting general-purpose secondary batteries in parallel and/or in series to be capable of outputting a predetermined voltage and capacitance and being charged, and combining the obtained battery blocks in many ways to be applicable to various applications is beginning to be used. In the module formation technique, the performance of the batteries accommodated in the battery blocks is enhanced to reduce the size and the weight of the battery blocks themselves. Thus, the module formation technique has various advantages such as improvement of workability in assembling battery modules, and improvement of flexibility in mounting the battery modules in areas of limited space, such as a vehicle.

However, when such battery blocks are used as a power supply of an electric vehicle, measures against emergency has to be taken in advance in addition to conditions for normal use. An example of the emergency may be a car accident.

Since impact force of a vehicle crash is large, air bags are provided to protect passengers from the impact force. However, it has not been long since battery modules were mounted as power supplies for driving devices in vehicles, and safety measures during crashes have not been specifically studied for the battery modules. In particular, as secondary batteries for vehicle use, high-voltage high-energy-density lithium ion secondary batteries have drawn attention, and thus safety measures during crashes have to be taken for battery modules using the lithium ion secondary batteries. An internal short circuit formed due to external impact may result in a high temperature in the lithium ion secondary batteries, which may generate a large amount of gas. Thus, the internal short circuit has to be prevented.

Patent Document 1 describes an automobile battery unit including battery blocks in which battery cells are aligned, an accommodation case in which the battery blocks are accommodated, a protection member provided on a circumferential surface of the accommodation case, and an outwardly protruding hollow swelling section formed on the protection member, where the type of the cells is not specified. Patent Document 1 describes that in such a battery unit, even when impact force is applied to the circumferential surface of the battery unit, plastic deformation of the hollow swelling section provided on the circumferential surface can reduce the impact force propagating to the battery blocks accommodated in the accommodation case.

### CITATION LIST

### Patent Document

PATENT DOCUMENT 1: Japanese Patent Publication No. 2008-269895

### SUMMARY OF THE INVENTION

### Technical Problem

However, battery modules for vehicle use are placed under a floor of a passenger compartment, behind a backseat, in a front engine room, or the like, and thus the size of the battery modules themselves has to be reduced as much as possible in order to obtain the largest possible space for the passenger compartment. The technique described in Patent Document 1 also requires additionally attaching the protection member including the swelling section to an outer side of each battery module. This caused problems where the size and the cost of each battery module increase by the protection member.

Moreover, it was attempted to provide an air bag to absorb impact during a crash, but it was very difficult to ensure space allowing inflation of the air bag, and providing the air bag increased the size of the battery modules themselves, thereby increasing cost.

In view of the foregoing, the present invention was devised. It is an objective of the present invention to provide a battery module for vehicle use which includes a shock absorbing member configured to absorb impact force of a crash without increasing the overall size of the battery module.

### Solution To the Problem

A battery block of the present invention is a battery block for vehicle use which includes an accommodation section accommodating a plurality of cells serving as secondary batteries, and an exhaust passage including space allowing a flow of gas generated from at least one of the cells, the battery block including: a shock absorbing member, wherein when impact of a vehicle crash is exerted on the battery block, the shock absorbing member deforms to reduce the space of the exhaust passage so as to absorb the impact. The shock absorbing member is a member configured to receive and attenuate impact to reduce or eliminate the impact on the other sections of the battery blocks.

A battery module of the present invention is a battery module for vehicle use which includes an accommodation section accommodating a plurality of cells serving as secondary batteries, and an exhaust passage including space allowing a flow of gas generated from at least one of the cells, the battery module including: a shock absorbing member, wherein when impact of a vehicle crash is exerted on the battery module, the shock absorbing member deforms to reduce the space of the exhaust passage so as to absorb the impact. Note that a minimum unit of a set of a plurality of cells is a battery block, and a battery module includes a plurality of battery blocks connected to each other.

A battery pack arrangement structure of the present invention includes multiple ones of the battery module arranged on a chassis, wherein a direction in which the exhaust passages extend is a direction substantially orthogonal to the width direction of a vehicle.

### Advantages of the Invention

The battery module of the present invention absorbs impact by reducing the space of the exhaust passage, so that it is not necessary to add new space to absorb the impact, and the shock absorbing member can be added without major changes in size of the battery module.

### BRIEF DESCRIPTION OF THE DRAWINGS

FIG. 1 is a cross-sectional view schematically illustrating a configuration of a cell used in a battery block of an embodiment.

FIG. 2 is a cross-sectional view schematically illustrating a configuration of the battery block of the embodiment.

FIG. 3 is a view illustrating a configuration of a battery module of the embodiment.

FIG. 4 is a cross-sectional view schematically illustrating the battery module taken along the line A-A of FIG. 3, where the battery module is covered with a lid.

FIG. 5 is a cross-sectional view schematically illustrating a battery module according to another example of the embodiment.

FIG. 6 is a cross-sectional view schematically illustrating a battery module according to another example of the embodiment.

FIG. 7 is a cross-sectional view schematically illustrating a battery module according to another example of the embodiment.

FIG. 8 is a view illustrating a configuration in which multiple ones of the battery module of the embodiment are arranged on a chassis.

FIG. 9 is a cross-sectional view schematically illustrating a battery module according to another example of the embodiment.

FIG. 10 is a cross-sectional view schematically illustrating a battery module according to another example of the embodiment.

FIG. 11 is a cross-sectional view schematically illustrating a battery module according to another example of the embodiment.

FIG. 12 is a view illustrating another configuration in which multiple ones of the battery module of the embodiment are arranged on a chassis.

### DESCRIPTION OF EMBODIMENTS

Embodiments of the present invention will be described in detail below with reference to the drawings. In the drawings, like reference characters have been used to designate elements having substantially the same functions for the sake of brevity of description.

### First Embodiment

### <Cell>

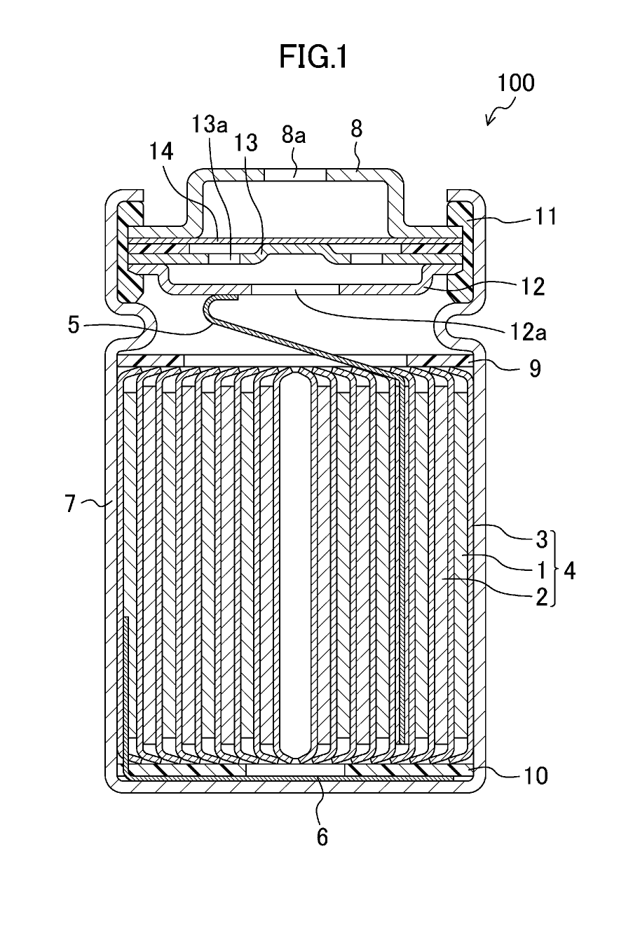

FIG. 1 is a cross-sectional view schematically illustrating a configuration of a battery 100 used in a battery block of a first embodiment. Note that the battery used in the battery block of the present embodiment may be a battery which can also be used alone as a power supply of portable electronic devices such as lap top computers (hereinafter, batteries used in a battery block are referred to as “cells”). In this case, a high-performance general-purpose battery can be used as the cell in the battery block, and thus, performance enhancement and const reduction of the battery block can easily be made. The battery of the present embodiment may be a cylindrical battery, a rectangular battery, or a laminate battery.

The cell 100 used in the battery block of the present embodiment may be, but not limited to a cylindrical lithium ion secondary battery as illustrated in FIG. 1. Alternatively, the cell 100 may be a rectangular battery. The lithium ion secondary battery has a general configuration, and includes a safety mechanism to release gas outside the battery when the pressure in the battery is increased due to the occurrence of an internal short circuit, or the like. With reference to FIG. 1, a specific configuration of the cell 100 will be described below.

As illustrated in FIG. 1, an electrode group 4 formed by winding a positive electrode 2 and a negative electrode 1 with a separator 3 interposed between the positive electrode 2 and the negative electrode 1 is accommodated in a cell case 7 together with a nonaqueous electrolyte. Part of the cell case 7 in which the electrode group 4 including the positive electrode 2 and the negative electrode 1 serving as power-generating elements is accommodated can be referred to as a main body section of the cell. Insulating plates 9, 10 are disposed above and under the electrode group 4. The positive electrode 2 is joined to a filter 12 via a positive electrode lead 5, and the negative electrode 1 is joined to a bottom of the cell case 7 via a negative electrode lead 6, the bottom also serving as a negative electrode terminal.

The filter 12 is connected to an inner cap 13, and a raised section of the inner cap 13 is joined to a metal valve plate 14. Moreover, the valve plate 14 is connected to a terminal plate 8 also serving as a positive electrode terminal. The terminal plate 8, the valve plate 14, the inner cap 13, and the filter 12 together seal an opening of the cell case 7 via a gasket 11.

When the pressure in the cell 100 is increased due to an internal short circuit, or the like formed in the cell 100, the valve body 14 expands toward the terminal plate 8, and if the joint between the inner cap 13 and the valve body 14 is released, a current path is interrupted. When the pressure in the cell 100 further increases, the valve body 14 ruptures. Thus, gas generated in the cell 100 is released outside via a through hole 12a of the filter 12, a through hole 13a of the inner cap 13, the ruptured part of the valve body 14, and an opening portion 8a of the terminal plate 8.

Note that the safety mechanism to release the gas generated in the cell 100 to the outside is not limited to the structure illustrated in FIG. 1, and may have other structures.

### <Battery Block>

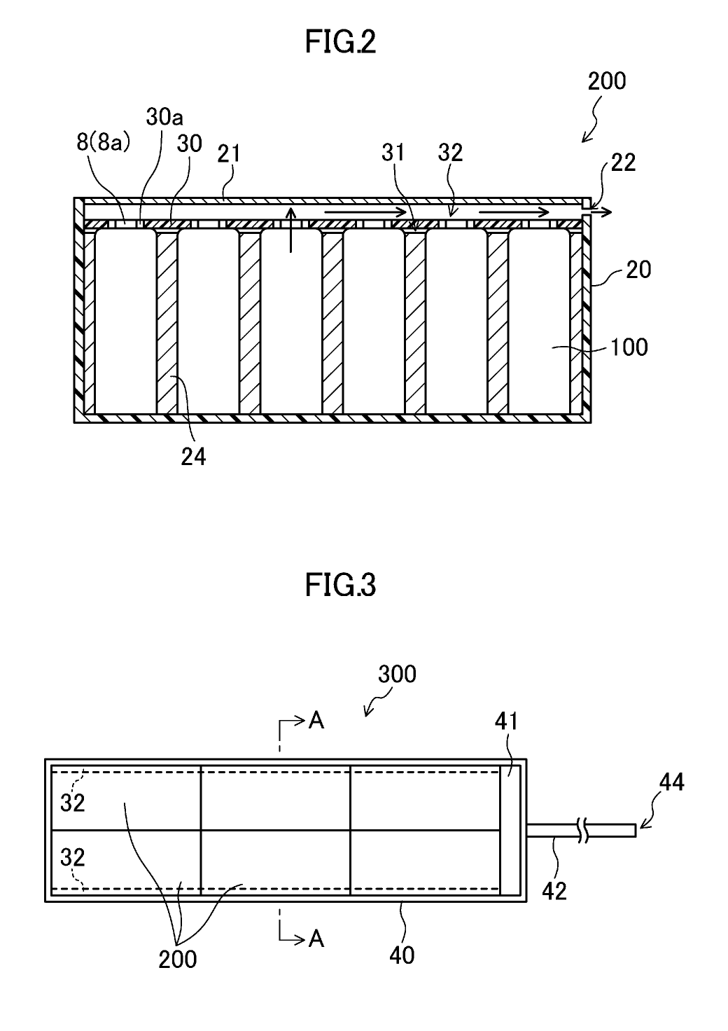

FIG. 2 is a cross-sectional view schematically illustrating a configuration of a battery block 200 of the present embodiment. In the present embodiment, the battery block 200 is the minimum unit of a set including multiple ones of the cell 100, and the cells 100 in one battery block 200 are connected to each other in parallel. Note that members and the like electrically connecting the cells 100 to each other are omitted to simplify this illustration.

In FIG. 2, a cross section of the plurality of cells 100 aligned and connected to each other in parallel is schematically illustrated (cross sections of the cells are not hatched for clarity), and the battery block 200 has a configuration in which the plurality of cells 100 are accommodated in a container 20.

The main body sections of the cells 100 are inserted into cylindrical through holes formed in a cooling block 24 (accommodation section) accommodated in the container 20, and the cells 100 are aligned with their main body sections being adjacent to each other. Moreover, as illustrated in FIG. 1, each cell 100 includes the opening portion 8a through which the gas generated in the cell 100 is released to the outside. The cells 100 are aligned with their opening portions 8a facing the same direction (face upward in FIG. 2) in the battery block 200.

A flat plate (plate-like member) 30 disposed on one side of the plurality of cells 100 (to face the positive electrode terminals 8 in the present embodiment) partitions the container 20 into storage space 31 in which the plurality of cells 100 are accommodated and an exhaust passage 32 through which gas released from the opening portion 8a of the cell 100 passes and is released outside the container 20. The opening portions 8a of the cells 100 are in communication with the exhaust passage 32 via openings 30a formed in the flat plate 30.

The exhaust passage 32 includes space between the flat plate 30 and a gutter-like member 21 which is an outer plate also serving as a lid of the container 20. All the opening portions 8a of the cells 100 are on the upper side of FIG. 2, the gutter-like member 21 is placed above the opening portions 8a, and the opening portions 8a are covered with the gutter-like member 21. Gas released through the opening portion 8a of the cell 100 is released to the exhaust passage 32 via the opening 30a formed in the flat plate 30, flows through the exhaust passage 32, and is released from an outlet 22 provided to the container 20 to the outside of the container 20.

Note that the flat plate 30 is disposed to be intimately in contact with ends of the cells 100 (in the present embodiment, ends closer to the positive electrode terminals 8), so that the storage space 31 is hermetically closed with the flat plate 30. Thus, the gas released from the opening portion 8a of the cell 100 via the opening 30a of the flat plate 30 to the exhaust passage 32 does not enter the storage space 31.

### <Battery Module>

FIG. 3 is a top view schematically illustrating a battery module 300 according to the present embodiment without an upper lid of a metal case 40. The battery module 300 includes an even number of battery blocks 200, 200, . . . (six battery blocks in the present embodiment) accommodated in the case 40, and is provided with a gas release duct 42. In the figure, two battery blocks 200 in the vertical direction form a pair, and three pairs are aligned in the horizontal direction. Therefore, the direction in which the three pairs are aligned, that is, the horizontal direction in the figure, is hereinafter referred to as a longitudinal direction of the battery module 300. In each pair, the battery blocks are arranged so that the exhaust passages 32 face outward and inner sides of the battery blocks are adjacent to each other. Moreover, the battery module 300 itself is substantially a rectangular parallelepiped. Assuming that a battery block 200 consists of an exhaust passage 32 and a main body section other than the exhaust passage, the paired two battery blocks 200, 200 have such a configuration that the main body sections adjacent to each other are sandwiched between the exhaust passages 32, 32 of the battery blocks 200, 200. In other words, the exhaust passage 32 and a part of one of the battery blocks 200, 200 which is adjacent to the other of the paired battery blocks 200, 200 are located on opposite ends of the one of the battery blocks 200, 200.

In the battery module 300, the exhaust passages 32 of the battery blocks 200, 200, . . . are arranged to face two surfaces of the battery module 300 which face each other, and reach a gas chamber 41 which is buffer-like space via the outlets 22. The gas chamber 41 is connected to the gas release duct 42, and gas generated from any of the cells 100 is released from the exhaust passage 32 via the outlet 22, the gas chamber 41, and the gas release duct 42 to the outside of the battery module 300.

The gas chamber 41 is disposed between one side surface of the battery block 200 and an inner surface of one side wall of the case 40. The gas chamber 41 includes space extending substantially vertical to a direction in which the exhaust passages 32 in the battery module 300 extend and are aligned in a row (the longitudinal direction of the battery module 300). The space extends to correspond to the entire surface of the side wall of the case 40.

An exit 44 of the gas release duct 42 is arranged in a position which is safe for gas release. When the battery module 300 is mounted in an electric vehicle, the battery module 300 is arranged, for example, between a passenger compartment and an exterior plate, or under a car body so that the exit 44 faces the ground. This arrangement is safe for passengers and people in the vicinity of the vehicle, and prevents gas from being blown to flammable materials inside the vehicle. Note that the installation position of the exit 44 of the gas release duct 42 depends on the structure of the vehicle and the installation position of the battery module 300.

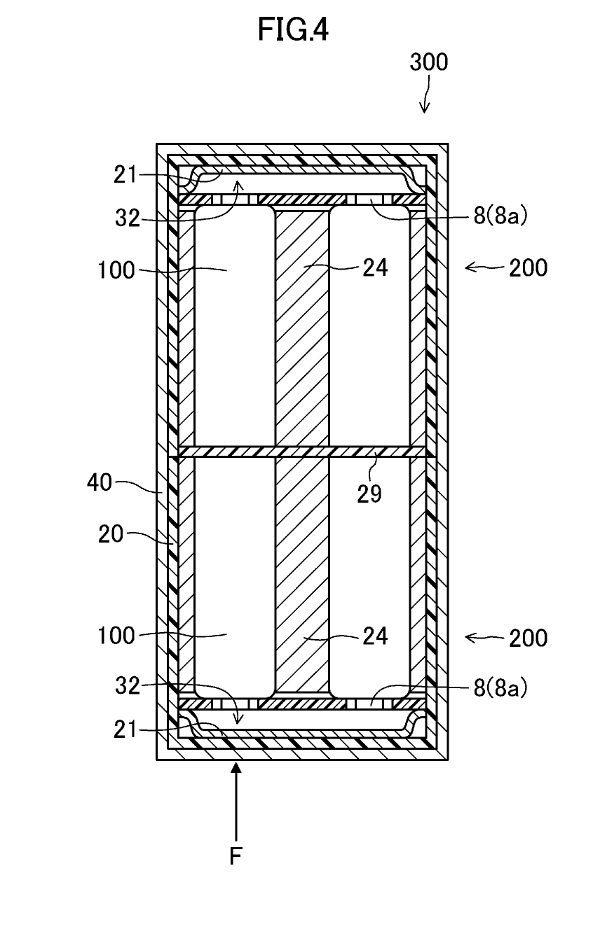

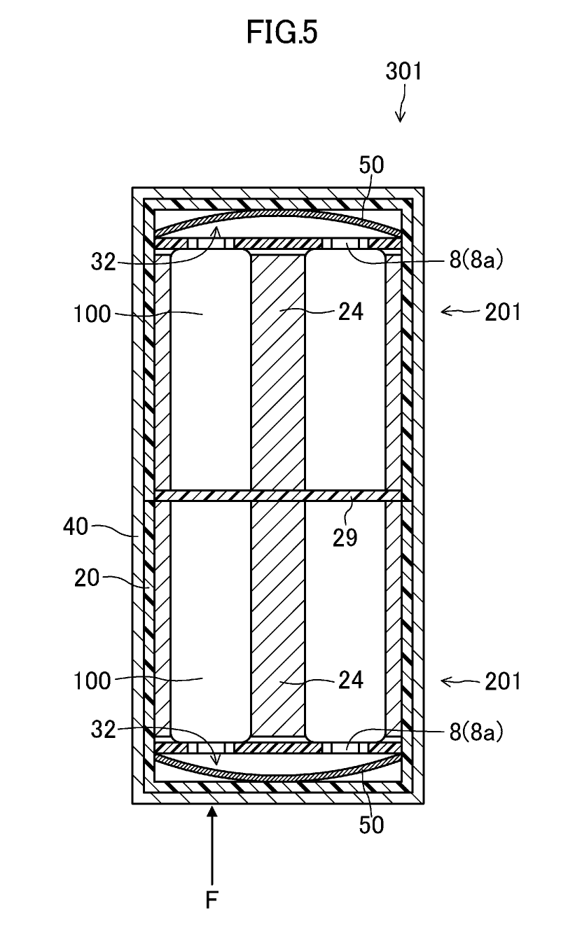

FIG. 4 is a cross-sectional view illustrating the battery module 300 taken along the line A-A of FIG. 3, where the battery module 300 is covered with the lid. Note that the cells 100 are not hatched. The exhaust passages 32, 32 of the upper and lower battery blocks 200, 200 are respectively arranged on an upper surface and a lower surface of the battery module 300, and the main body sections (sections in which the cells 100 are aligned) of the upper and lower battery blocks 200, 200 are arranged between the exhaust passages 32, 32.

FIG. 8 shows battery pack arrangement of the present embodiment in which a plurality of battery modules 300, 300, . . . are mounted on a chassis 60. Here, a combination of a plurality of battery modules is referred to as a battery pack. The number of battery modules 300, 300, . . . arranged between rear wheels 62, 62 is three. The number of battery modules 300, 300, . . . arranged between front wheels 61, 61 and the rear wheels 62, 62 is five. The exhaust passages 32 in all of the battery modules 300, 300, . . . extend in the longitudinal direction of the vehicle. That is, the direction in which the exhaust passages 32 extend is substantially vertical to the width direction of the vehicle. The term “substantially vertical” means that there may be a case where the direction slightly deviates from the vertical direction in a strictly mathematical sense due to design conditions, tolerance in assembling the battery modules to the chassis, or the like. Note that the exhaust passages 32 are arranged along side surfaces of each battery module 300 which extend in the longitudinal direction of the vehicle, and there is a gap between the battery modules 300 adjacent to each other.

Next, a crush in an accident of a vehicle in which the battery modules 300 of the present embodiment are mounted will be described.

Safety measures of vehicles in order to ensure safety for passengers have been studied over many years, and various techniques are used, but safety measures of electric vehicles are not specifically studied. In general, it is so devised that an engine room or a luggage room serves as a crush zone in a frontal crash or a rare crash of a vehicle so that the crash does not impact on passengers, which also brings benefits to battery modules. However, since no crash zone is provided for a side crash, that is, a crash in the width direction of the vehicle, impact of the crash is poorly reduced and is transferred to the battery modules 300.

As described above, in the case of a side crash of a vehicle in which battery modules are mounted, large impact is exerted in a lateral direction of the battery modules 300 (a direction substantially orthogonal to the longitudinal direction of the battery modules 300), and the impact cannot be satisfactorily absorbed only by the cases 40, so that the large impact may be exerted on the cells 100 in the battery modules 300. When the large impact is thus exerted on the cells 100, the cells 100 may deform, thereby forming an internal short circuit. When the internal short circuit is formed, high-temperature gas is released from the cell 100, so that the cell 100 is no longer usable, and heat may form internal short circuits in the peripheral cells 100 in a chain reaction.

In the case of the arrangement of the battery pack including the plurality of battery modules 300 illustrated in FIG. 8, when a side crash of the vehicle occurs, impact force denoted by F in FIG. 4 is exerted on the battery modules 300 in the direction illustrated in FIG. 4. With the stiffness of the case 40, not all of the impact force F can be absorbed, so that the impact is also exerted on the battery blocks 200. Here, the direction of the impact force F is a direction along a columnar center axis of each cell 100, and if the impact force is exerted on the cells 100 without being reduced, upper portions of the cells 100 may be pushed into the exhaust passage 32, or compressive stress may be exerted on the center axes.

However, in the present embodiment, the gutter-like member 21 is formed by winding a metal plate, and thus when the impact force is exerted on the gutter-like member 21, the impact force is absorbed by elastic deformation of the gutter-like member 21 when the impact force is small, or by plastic deformation of the gutter-like member 21 when the impact force is large. The deformation of the gutter-like member 21 crushes the exhaust passage 32, so that the size of space through which gas flows is reduced.

As described above, the gutter-like member 21 serving as a shock absorbing member deforms to absorb the impact due to the side crash of the vehicle, and to reduce the impact exerted on the cells 100 to zero or to such an extent that no internal short circuit, or the like is formed, so that it is possible to reduce the influence on the cells 100. In this way, it is possible to prevent the occurrence of an abnormal situation such as an internal short circuit in the cell 100 even in the case of a crash, so that a safety problem in the battery modules 300 does not arise even when a crash occurs. When the exhaust passage 32 is crushed due to the deformation of the gutter-like member 21, the battery module 300 may no longer be usable, but if there is a possibility of damage on the battery module 300 due to the crash, the battery module 300 is replaced with a new battery module in consideration of safety. Thus, rendering the battery module 300 no longer usable is not a particular problem.

Moreover, in the case of a frontal or rear crash of the vehicle, a bumper or a crush zone reduces impact of the crash, and additionally, in the present embodiment, the case 40 located laterally to the gas chamber 41 deforms to reduce the space of the gas chamber 41, thereby absorbing the impact, so that the battery module of the present embodiment has a high degree of safety against the frontal or rear crash of the vehicle. That is, even when impact is exerted in the longitudinal direction of the battery module 300, part of the case 40 located laterally to the gas chamber 41 serves as another shock absorbing member, so that the impact can be absorbed.

As described above, the gutter-like member 21 of the battery module 300 of the present embodiment is so devised that the gutter-like member 21 deforms to reduce the space of the exhaust passage 32. This is utilized to absorb impact of a crash, thereby preventing exertion of large impact on the cells 100. Thus, it is not necessary to provide a separate member in the battery module 300 in order to absorb impact, so that the size of the battery module 300 can be maintained small, and fabrication cost can be reduced.

Note that in terms of exertion of impact on the battery module 300, impact force of vibration in normal use of the vehicle also has to be taken into consideration, but the impact force here is about 5 G at most, and such a magnitude of impact force can be absorbed with the stiffness of the case 40, or the like. However, impact of a crash is larger by an order of magnitude, and is about 15-50 G. In a design in which the impact of a crash is absorbed by the case 40, or the like, the size and weight of the battery module are increased by the shock absorbing member, and cost is also increased. Moreover, the impact force of vibration is continuously exerted on the battery module 300 in normal use of the vehicle, and thus if the impact force of vibration hinder the use of battery module 300, that is a problem. However, since a crash in an accident is a state of emergency, priority is given to safety, whereas maintaining the battery module 300 to be usable has a low priority, and the impact of the crash need be absorbed by deformation of the gutter-like member 21 and a crush of the exhaust passage 32 as described above.

### First Variation

A first variation has the same structure as that of the above-described embodiment except the structure for absorbing impact of a crash. Thus, only the difference from the above-described structure will be described below. The configurations and structures of cells, battery blocks, and battery modules, and the arrangement of the cells, battery blocks, and battery modules on a chassis description of which is omitted are the same as those of the above-described embodiment.

As illustrated in FIG. 5, the shape of gutter-like member 50 of a battery module 301 according to the first variation is different from that of the above-described embodiment. Also in the present variation, the gutter-like member 50 serves as a shock absorbing member.

The gutter-like member 50 here is made of a metal plate having an arc-shaped cross section (a member such as phosphor bronze having a spring property). When impact force F due to a crash is exerted on the battery module 301 of the present variation, the gutter-like member 50 deforms to reduce space of an exhaust passage 32, thereby absorbing the impact, so that the impact exerted on cells 100 is reduced to zero or to such an extent that no internal short circuit, or the like is formed.

In the first variation, when force is exerted in a direction of the impact force F, the entirety of the gutter-like member 50 serves as a plate spring to absorb the impact. Thus, the first variation can absorb larger impact than the above-described embodiment. Other advantages are the same as those of the above-described embodiment.

### Second Variation

A second variation has the same structure as that of the above-described embodiment except the structure for absorbing impact of a crash. Thus, only the difference from the above-described structure will be described below. The configurations and structures of cells, battery blocks, and battery modules, and the arrangement of the cells, battery blocks, and battery modules on a chassis description of which is omitted are the same as those of the above-described embodiment.

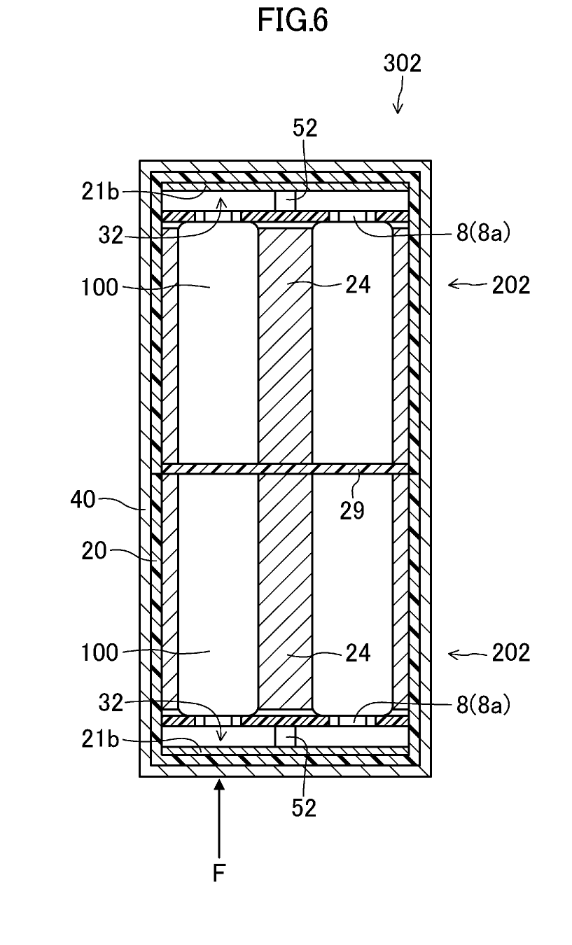

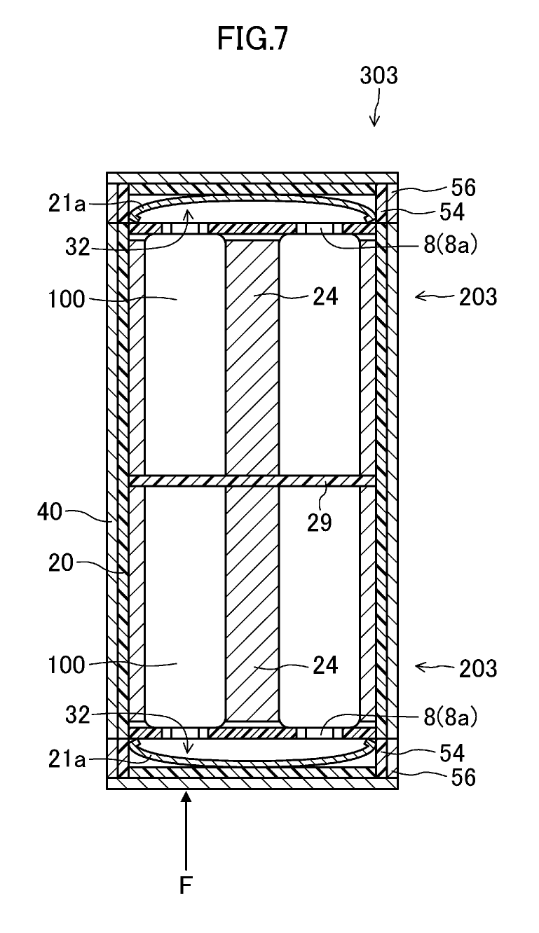

As illustrated in FIG. 6, a battery module 302 according to the second variation has the configuration of the above-described embodiment, and additionally includes at least one reinforcing member 52 arranged in space of an exhaust passage 32, wherein a gutter-like member 21 and the reinforcing member 52 serve as a shock absorbing member.

The reinforcing member 52 is made of a columnar elastic member, and is disposed at the center in the width direction of the exhaust passage 32 in each of battery blocks 202. Multiple ones of the reinforcing member 52 may be arranged in a direction in which the exhaust passage 32 extends. Moreover, each of outer plates 21b forming the exhaust passages 32 is in the shape of a flat plate, and a center portion of the outer plate 21b is supported by the reinforcing member 52.

When impact force F due to a crash is exerted on the battery module 302 of the present variation, the reinforcing member 52 deforms to reduce the space of the exhaust passage 32, thereby absorbing the impact, so that the impact exerted on cells 100 is reduced to zero or to such an extent that no internal short circuit, or the like is formed.

In the second variation, the reinforcing member 52 having greater impact absorbing power than the gutter-like member 21 is arranged as part of the shock absorbing member. Thus, the second variation can absorb larger impact than the above-described embodiment. Other advantages are the same as those of the above-described embodiment.

### Third Variation

A third variation has the same structure as that of the above-described embodiment except the structure for absorbing impact of a crash. Thus, only the difference from the above-described structure will be described below. The configurations and structures of cells, battery blocks, and battery modules, and the arrangement of the cells, battery blocks, and battery modules on a chassis description of which is omitted are the same as those of the above-described embodiment.

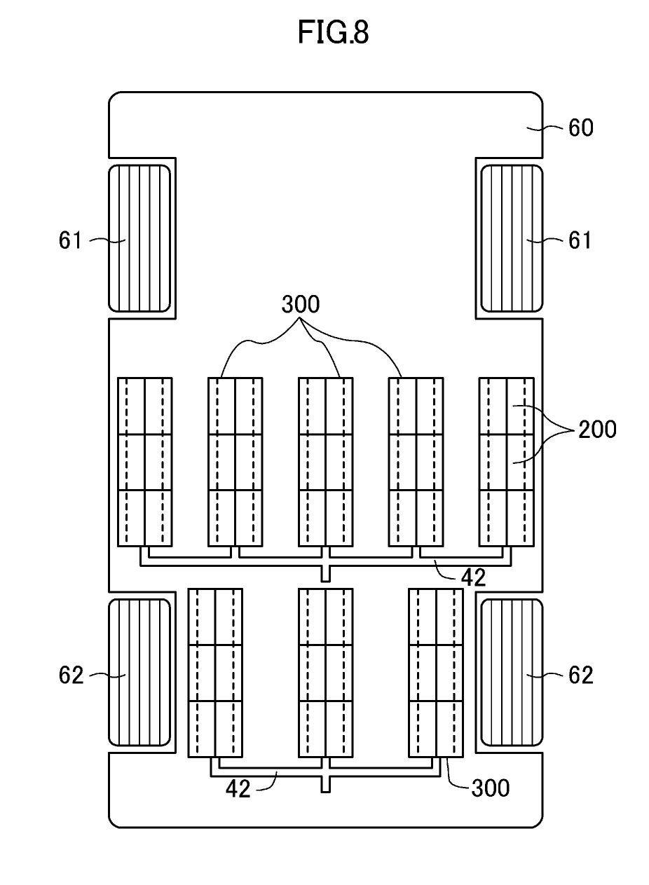

As illustrated in FIG. 7, a battery module 303 according to the third variation has the configuration of the above-described embodiment, and is additionally configured such that parts of containers 20 and a case 40 arranged laterally to exhaust passages 32 are made of different materials, and/or are formed to have different shapes from the other parts of the containers 20 and the case 40, thereby forming first shock absorbing belt sections 54 and second shock absorbing belt sections 56. Moreover, the shape of gutter-like members 21a of the battery module 303 is different from that of the above-described embodiment. The gutter-like member 21a, the first shock absorbing belt section 54, and the second shock absorbing belt section 56 serve as a shock absorbing member.

The first shock absorbing belt section 54 and the second shock absorbing belt section 56 are made of materials having higher impact absorbing power than materials forming the other sections of the container 20 and the case 40, and/or are formed into a shape having higher impact absorbing power than the other sections of the container 20 and the case 40. The first shock absorbing belt section 54 and the second shock absorbing belt section 56 surround the exhaust passage 32 as belts of each of battery blocks 203.

The cross section of the gutter-like member 21a is similar to that of the gutter-like member 50 of the first variation. The difference from the first variation is that both ends of the arc-shaped cross section extend to the first shock absorbing belt section 54, and both the ends are folded inside the arc, thereby forming folded parts. The folded parts inside the arc are short, and corner sections of the folded parts touch an inner side of the first shock absorbing belt section 54 to outwardly press the first shock absorbing belt section 54.

In an example configuration of the first shock absorbing belt section 54 and the second shock absorbing belt section 56, for example, an elastic member having a high elastic coefficient and a plastic deformation member are combined with each other so that the plastic deformation member falls outside the battery module 303 when compressive force is applied to the plastic deformation member. In this case, when impact is exerted, the elastic member first deforms, and the gutter-like member 21a is crushed, so that the height of the exhaust passage 32 is reduced, and then the plastic deformation member deforms. After a certain degree of deformation by compression, the plastic deformation member is pressed by corners of the gutter-like member 21a and deforms so that the plastic deformation member falls outside the battery module 303. At this instant, the elastic member is free from the compressive force, and returns to its initial state. Further, when the impact is continuously exerted so that space of the exhaust passage 32 is reduced, the elastic member is compressed again, and deforms to absorb the impact.

As described above, when impact force F due to a crash is exerted on the battery module 303 of the present variation, the gutter-like member 21a and both the first shock absorbing belt section 54 and the second shock absorbing belt section 56 deform to reduce the space of the exhaust passage 32, thereby absorbing the impact, so that the impact exerted on the cells 100 can be reduced to zero or to such an extent that no internal short circuit, or the like is formed.

In the third variation, the first shock absorbing belt section 54 and the second shock absorbing belt section 56 are arranged as parts of the shock absorbing member. Thus, the third variation can absorb larger impact than the above-described embodiment. Other advantages are the same as those of the above-described embodiment.

Note that the configuration and the structure of the first shock absorbing belt section 54 and the second shock absorbing belt section 56 are not limited to the above-described example. Any configuration and structure may be possible as long as the sections are made of a material having higher impact absorbing power, and/or are formed into a shape having higher impact absorbing power than materials forming the other sections of the container 20 and the case 40.

### Fourth Variation

A fourth variation has the same structure as that of the above-described embodiment except the structure for absorbing impact of a crash. Thus, only the difference from the above-described structure will be described below. The configurations and structures of cells, battery blocks, and battery modules, and the arrangement of the cells, battery blocks, and battery modules on a chassis description of which is omitted are the same as those of the above-described embodiment.

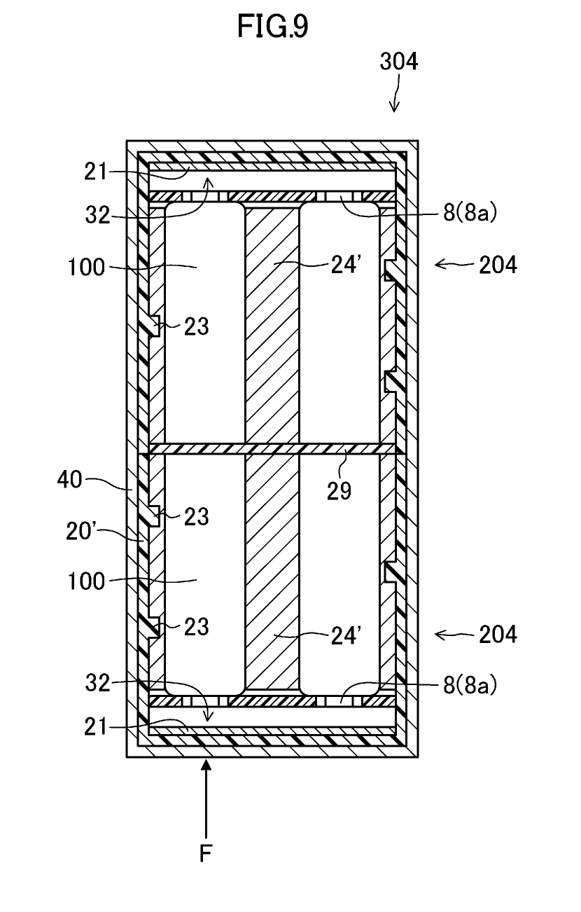

As illustrated in FIG. 9, a battery module 304 according to the fourth variation has the configuration of the above-described embodiment, and additionally includes raised sections 23, 23, 23 projecting from an inner side of a container 20′ of each of battery blocks 204. Recessed sections are formed in portions of a cooling block 24′ which correspond to the raised sections 23.

When impact force F due to a crash is exerted on the battery module 304 according to the present variation, the raised sections 23, 23, 23 of the container 20′ made of resin deforms to absorb the impact force. When the impact force is greater than force which can be absorbed by the deformation, the raised sections 23, 23, 23 are broken so that an upper gutter-like member 21 deforms to absorb the impact force.

In the fourth variation, in addition to the gutter-like member 21, the raised sections 23, 23, 23 are arranged as a shock absorbing member. Thus, the fourth variation can absorb larger impact than the above-described embodiment. Other advantages are the same as those of the above-described embodiment.

### Fifth Variation

A fifth variation has the same structure as that of the above-described embodiment except the structure for absorbing impact of a crash. Thus, only the difference from the above-described structure will be described below. The configurations and structures of cells, battery blocks, and battery modules, and the arrangement of the cells, battery blocks, and battery modules on a chassis description of which is omitted are the same as those of the above-described embodiment.

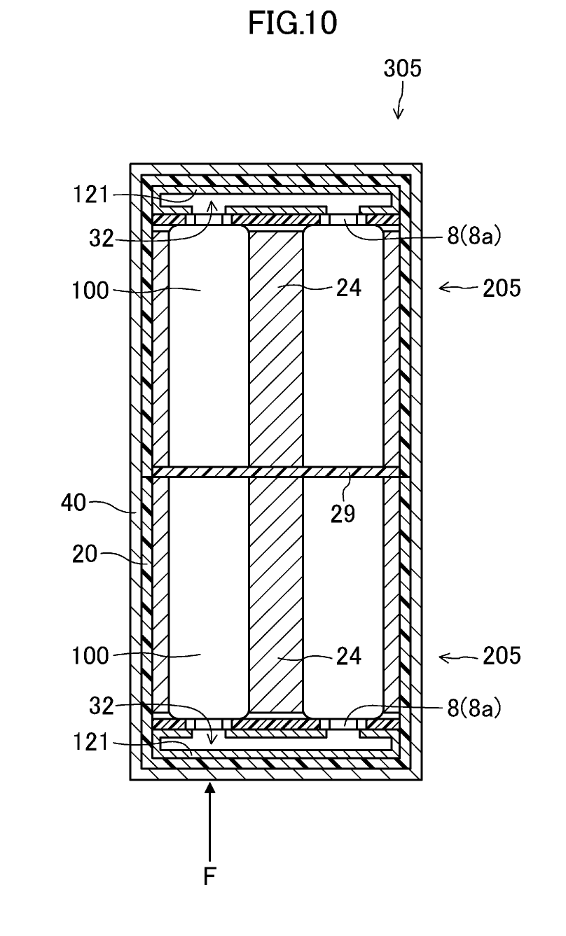

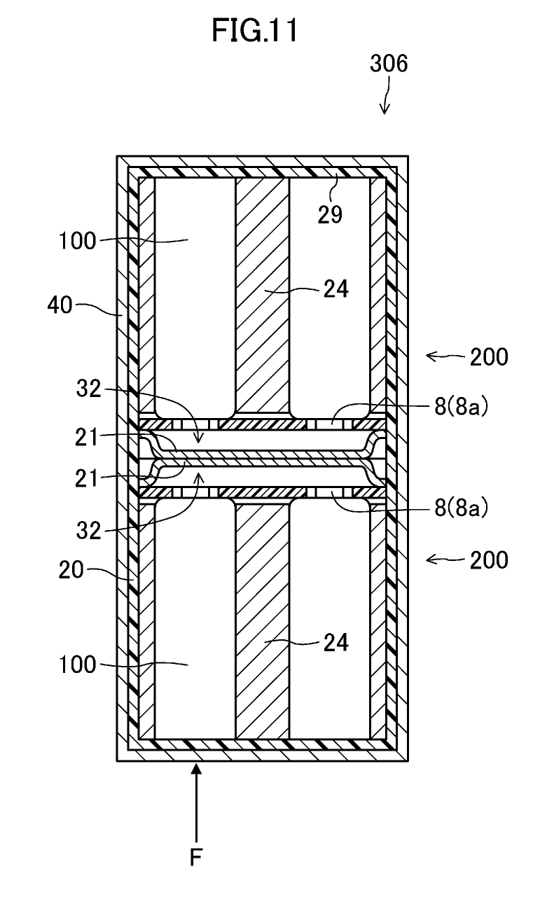

As illustrated in FIG. 10, a battery module 305 according to the fifth variation is different from the configuration of the above-described embodiment in that a tubular hollow member 121 is used instead of the gutter-like member 50. In the present variation, the tubular hollow member 121 serves as a shock absorbing member.

The tubular hollow member 121 here is made of an iron square pipe, and a hollow portion of the tubular hollow member 121 serves as an exhaust passage 32. Moreover, holes are formed in portions of the hollow member 121 which correspond to opening portions 8a of cells 100, so that gas released from the cells 100 can be rapidly sent to the exhaust passage 32. When impact force F due to a crash is exerted on the battery module 305 of the present variation, the hollow member 121 deforms to reduce space of the exhaust passage 32, thereby absorbing the impact, so that the impact exerted on the cells 100 is reduced to zero or to such an extent that no internal short circuit, or the like is formed.

In the fifth variation, when force is exerted in a direction of the impact force F, the tubular hollow member 121 deforms to absorb the impact. Thus, the fifth variation can absorb larger impact than the above-described embodiment. Other advantages are the same as those of the above-described embodiment.

### Sixth Variation

A sixth variation has the same structure as that of the above-described embodiment except the structure of the battery module. Thus, only the difference from the above-described structure will be described below. The configurations and structures of cells and battery blocks, and the arrangement of the cells and battery blocks on a chassis description of which is omitted are the same as those of the above-described embodiment.

As illustrated in FIG. 11, a battery module 306 according to the sixth variation is different from the configuration of the above-described embodiment in that battery blocks 200, 200 in a pair are arranged with their exhaust passages 32 facing each other. In the present variation, members for absorbing impact of a crash are gutter-like members 21, 21, which are the same as those in the above-described embodiment. At the center of the battery module 306, the two gutter-like members 21, 21 are placed with upper surfaces thereof being in contact with each other, which results in a structure for absorbing the impact due to the crash at the center of the battery module 306. The impact force due to the crash is absorbed by deformation of a weakest portion of the battery module 306, and thus advantages the same as those of the above-described embodiment can be obtained even when the shock absorbing member is arranged at the center of the battery module.

### Other Embodiments

The above-described embodiment is an example of the present invention, and is not intended to limit the present invention. Materials or the thickness of the gutter-like member 21 may be modified, or the shape of the gutter-like member 21 may be changed. For example, a reinforcing rib may be provided on an upper surface or a side surface of the gutter-like member 21, or a recessed portion and a raised portion may be formed in the metal plate to increase stiffness or elasticity.

An arrangement configuration of the battery modules on a chassis may be other than the configuration illustrated in FIG. 8. The battery modules may be arranged with their exhaust passages extending in the width direction of a vehicle, or battery modules whose exhaust passages extend in the width direction of the vehicle and battery modules whose exhaust passages extend in the longitudinal direction of the vehicle may be used in combination. Alternatively, the battery modules may be stacked on a plurality of levels.

The reinforcing member of the second variation may be made of a member which plastically deforms to absorbs impact.

The shock absorbing members of the above-described embodiment and variations may be used in combination.

In the fourth variation, the raised sections may be formed on the cooling block, and the recessed sections corresponding to the raised sections may be formed on the container.

In the first to fifth variations, a battery module structure in which the shock absorbing member is arranged at the center may be used as in the case of the sixth variation.

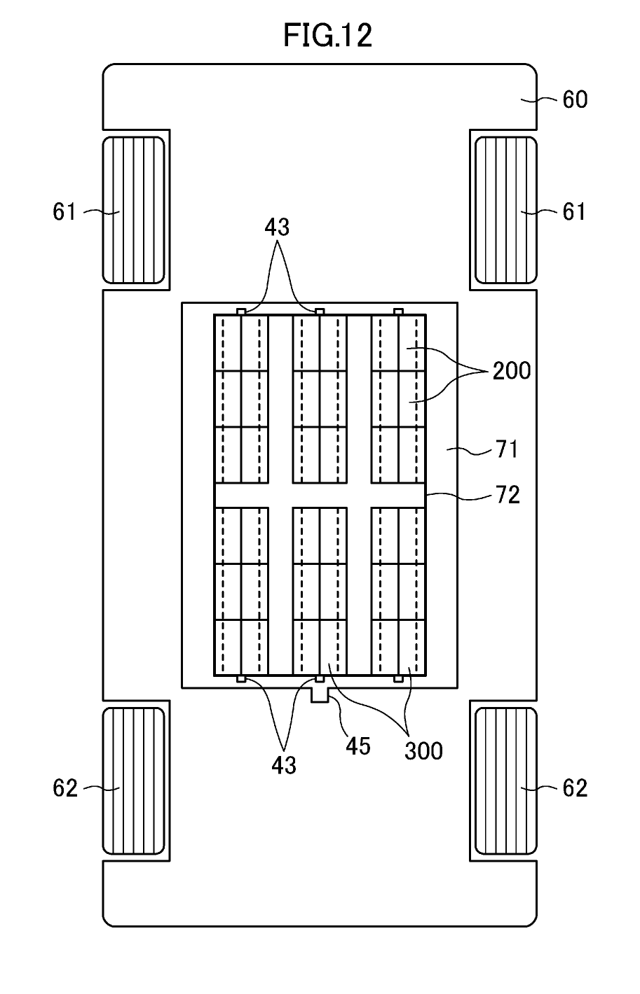

Moreover, battery pack arrangement illustrated in FIG. 12 may be used. A major difference of the battery pack arrangement illustrated in FIG. 12 from the battery pack arrangement of FIG. 8 is that a plurality of battery modules 300, 300, . . . are accommodated in an inner case 72, and a gas release path 71 for absorbing impact is provided outside the inner case 72. Moreover, the battery pack arrangement of FIG. 12 is different from that of FIG. 8 in that gas release ducts 43 of the battery modules 300 are not connected to each other between the battery modules 300, and an exit of the gas release duct 43 of each of the battery modules 300 is connected to the gas release path 71. Six battery modules 300, 300, . . . are accommodated in the inner case 72, and exhaust passages 32 of each of the battery modules 300, 300, . . . extend in the longitudinal direction of the vehicle, and the direction in which the exhaust passages 32 extend is substantially orthogonal to the width direction of the vehicle.

In the battery pack arrangement illustrated in FIG. 12, the gas release path 71 is provided around a set of the battery modules 300, 300, . . . when viewed from above, and a gas exit 45 of the gas release path 71 is formed on a rear side of the vehicle. With this battery pack arrangement, the advantage of absorbing impact by deformation of the gas release path 71 can be obtained in addition to the advantages obtained from the battery pack arrangement of FIG. 8. For example, when a vehicle is hit by another vehicle, an outer wall of the gas release path 71 is inwardly dented, thereby absorbing the impact of the crash. With the structure illustrated in FIG. 12, impact in the longitudinal direction of the vehicle can also be absorbed by deformation of the gas release path 71. In the battery pack arrangement illustrated in FIG. 12, the battery modules of the first to sixth variations may be used. Alternatively, the inner case 72 may be removed, and space between a set of the battery modules 300 and a case outside the battery pack may be used as a gas release path.

### INDUSTRIAL APPLICABILITY

As described above, a battery module according to the present invention has high impact absorptive power, and is useful for power supplies for vehicle use, or the like.

### DESCRIPTION OF REFERENCE CHARACTERS

1 Negative Electrode
2 Positive Electrode
4 Electrode Group
7 Battery Case (Negative Electrode Terminal)
8 Terminal Plate (Positive Electrode Terminal)
8a Opening Portion
21 Outer Plate (Gutter-Like Member)
21a Outer Plate (Gutter-Like Member)
24 Cooling Block (Accommodation Section)
32 Exhaust passage
40 Case
41 Gas Chamber
50 Gutter-Like Member (Shock Absorbing Member)
52 Reinforcing Member (Shock Absorbing Member)
54 First Shock Absorbing Belt Section
56 Second Shock Absorbing Belt Section
60 Chassis
100 Cell
121 Tubular Hollow Member (Shock Absorbing Member)
200 Battery Block
201 Battery Block
202 Battery Block
203 Battery Block
204 Battery Block
205 Battery Block
300 Battery Module
301 Battery Module
302 Battery Module
303 Battery Module
304 Battery Module
305 Battery Module
306 Battery Module

1. A battery block for vehicle use which includes an accommodation section accommodating a plurality of cells serving as secondary batteries, and an exhaust passage including space allowing a flow of gas generated from at least one of the cells, the battery block comprising:
a shock absorbing member, wherein
when impact of a vehicle crash is exerted on the battery block, the shock absorbing member deforms to reduce the space of the exhaust passage so as to absorb the impact.

2. The battery block of claim 1, wherein
the impact of the vehicle crash is impact of 15 G or greater.

3. The battery block of claim 1, wherein
each of the cells includes a cell main body section having a power-generating element, and an opening portion through which gas generated in the cell main body section is released outside the cell, and
the cells are accommodated in the accommodation section with the cell main body sections being adjacent to each other and the opening portions facing a same direction.

4. A battery block of claim 1, wherein
at least part of the exhaust passage is made of the shock absorbing member.

5. A battery block of claim 1, wherein
at least part of the shock absorbing member is a gutter-like member.

6. A battery block of claim 1, wherein
the shock absorbing member is made of an elastic member.

7. A battery block of claim 1, wherein
the shock absorbing member is made of a material which is plastically deformed by the impact.

8. A battery block of claim 1, wherein
the shock absorbing member is made of a tubular hollow member.

9. A battery block of claim 1, further comprising:
a case in which the accommodation section and the exhaust passage are accommodated, wherein
the accommodation section includes a raised section serving as the shock absorbing member,
the case includes a recessed section which accepts the raised section, and
the raised section is broken by the impact.

10. A battery block of claim 1, further comprising:
a case in which the accommodation section and the exhaust passage are accommodated, wherein
the case includes a raised section serving as the shock absorbing member,
the accommodation section includes a recessed section which accepts the raised section, and
the raised section is broken by the impact.

11. A battery module for vehicle use which includes an accommodation section accommodating a plurality of cells serving as secondary batteries, and an exhaust passage including space allowing a flow of gas generated from at least one of the cells, the battery module comprising:
a shock absorbing member, wherein
when impact of a vehicle crash is exerted on the battery module, the shock absorbing member deforms to reduce the space of the exhaust passage so as to absorb the impact.

12. The battery module of claim 11, wherein
the impact of the vehicle crash is impact of 15 G or greater.

13. The battery module of claim 11, wherein
each of the cells includes a cell main body section having a power-generating element, and an opening portion through which gas generated in the cell main body section is released outside the cell, and
the cells are accommodated in the accommodation section with the cell main body sections being adjacent to each other and the opening portions facing a same direction.

14. A battery module of claim 11, wherein
at least part of the exhaust passage is made of the shock absorbing member.

15. A battery module of claim 11, wherein
at least part of the shock absorbing member is a gutter-like member.

16. A battery module of claim 11, wherein
the shock absorbing member is made of an elastic member.

17. A battery module of claim 11, wherein
the shock absorbing member is made of a material which is plastically deformed by the impact.

18. A battery module of claim 11, wherein
the shock absorbing member is made of a tubular hollow member.

19. A battery module of claim 11, further comprising:
a case in which the accommodation section and the exhaust passage are accommodated, wherein
the accommodation section includes a raised section serving as the shock absorbing member,
the case includes a recessed section which accepts the raised section, and
the raised section is broken by the impact.

20. A battery module of claim 11, further comprising:
a case in which the accommodation section and the exhaust passage are accommodated, wherein
the case includes a raised section serving as the shock absorbing member,
the accommodation section includes a recessed section which accepts the raised section, and
the raised section is broken by the impact.

21. A battery module comprising:
an even number of ones of the battery block of any one of claims 1-10, wherein
any one of the battery blocks is paired with and is arranged to be adjacent to another one of the battery blocks,
the one of the battery blocks is configured such that a part adjacent to the another battery block and the exhaust passage are located on opposite ends of the one of the battery blocks,
the one of the battery blocks is adjacent to battery blocks other than the another battery block, and
the exhaust passages of the one of the battery blocks and the battery blocks other than the another battery block are connected to each other to extend in a row.

22. The battery module of claim 21, further comprising:
a gas chamber provided on one end of each of the battery module, wherein
the gas chamber is substantially orthogonal to the row in which the exhaust passages extend.

23. A battery pack arrangement structure comprising:
multiple ones of the battery module of claim 21 or 22 arranged on a chassis, wherein
a direction in which the exhaust passages extend is a direction substantially orthogonal to a width direction of the vehicle.
